(19) United States
(12) Patent Application Publication
(10) Pub. No.: US 2021/0224705 A1
(43) Pub. Date: Jul. 22, 2021

(54) METHOD AND SYSTEM FOR ATTAINING SUSTAINABLE PRODUCTIVITY GROWTH IN AN ENTITY

(71) Applicant: TIGHT LINE ADVISORS, LLC, Stamford, CT (US)

(72) Inventor: John ABPLANALP, Stamford, CT (US)

(73) Assignee: TIGHT LINE ADVISORS, LLC, Stamford, CT (US)

(21) Appl. No.: 17/222,482

(22) Filed: Apr. 5, 2021

Related U.S. Application Data
(63) Continuation of application No. PCT/US2019/054783, filed on Oct. 4, 2019.
(60) Provisional application No. 62/741,984, filed on Oct. 5, 2018.

(51) Int. Cl. G06Q 10/06; G06Q 30/02

(52) U.S. Cl. CPC G06Q 10/0637; G06Q 30/0201; G06Q 10/06393

(57) ABSTRACT

A system and method is provided for attaining sustainable productivity growth in an entity. The system and method provides visual representations of projected entity valuations, and productivity growth based on selected areas of improvement, including improved gross margins in manufacturing entities. The visual representations and projected values can be provided on a graphical user interface, that can be adjusted by the user.

### CROSS REFERENCE TO RELATED APPLICATIONS

This application is a continuation of International Patent Application No. PCT/US2019/054783 filed on Oct. 4, 2019 and claims the benefit under 35 U.S.C. § 119(e) of U.S. Provisional Application No. 62/741,984 filed Oct. 5, 2018 the contents of both are incorporated by reference herein in their entirety.

### BACKGROUND OF THE DISCLOSURE

### 1. Field of the Disclosure

The present disclosure relates to a method and a system for attaining sustainable productivity growth in an entity. More particularly, the present disclosure relates to a method and a system for attaining sustainable productivity growth resulting in improved gross margins in manufacturing entities. In addition, the present disclosure provides for projecting trends to productivity, and thus entity value, based on selected areas for improvement.

### 2. Description of the Related Art

Current practices for increasing an entity's valuation are rooted in “quick fix” or “low hanging fruit” methodologies. Such methods focus primarily on lowering fixed overhead costs. The usual solutions are to reduce personnel, outsource manufacturing costs to cheaper locations, and downsizing, which reduce employees and resources, but do not reduce the amount of work. While these solutions can provide temporary increases in valuation, continued growth is unsustainable.

However, it is difficult to quickly and accurately visualize and pinpoint the necessary areas for improvement and to determine in what order the improvements to different areas should be made, that would provide sustainable growth, such as improved profitability, liquidity and enhanced competitive positioning.

Thus, there is a need to address the foregoing problems.

### SUMMARY OF THE DISCLOSURE

The present disclosure provides a method and a system that addresses at least the aforementioned shortcomings of current methods of increasing entity valuations.

The present disclosure further provides such a method and system that focuses on increasing entity valuations through sustainable productivity growth, by identifying areas for improvement, and improving overall efficacy in the operations of the entity which lead to increased gross margins, improved profitability and enhanced competitive positioning, through decreasing the cost of goods, and addressing overall operating efficiencies.

The present disclosure also provides such a method and system that enables users to identify issues in production, explore opportunities, and take corrective actions through implementation of various improvements.

The present disclosure also provides that once one or more improvements are implemented, the user can reuse the method and system to identify new issues and/or areas of improvement to create continued growth and, thus, the entity uses the method and system to attain greater competitive positioning.

The present disclosure further provides such a method and system that collects data, such as financials, machine operating efficiencies, internal and external failures, material losses, and health and safety data via one or more sources.

The present disclosure yet further provides such a method and system that stores the data, and through a calculation unit, selects areas for improvement, which can include, but are not limited to, decreasing the cost of goods, increasing machine operating efficiencies, decreasing material losses, and decreasing costs from accidents involving health and safety.

The present disclosure further provides such a method and system that determines areas for improvement.

The present disclosure yet further provides such a method and system that determines the order in which the improvements should be implemented based on objective criteria such as comparison of the entity data to benchmarks obtained from the other entities in the same industry, sector or niche, or internal versus historic performance, or other similar internal operations.

The present disclosure still further provides such a method and system in which the determined areas for improvement can be selected through entity specific criteria, such as financial impacts, machine operating efficiencies, and other concerns specific to the entity being evaluated.

The present disclosure yet further provides such a method and system that provides projected trends, such as but not limited to, gross margins and entity valuation, based on the selected areas for improvement.

The present disclosure further provides such a method and system that enables the user to manually adjust which improvements are made, compare various improvements to each other, select in what order the improvements are made, and provides updated projected trends to productivity and entity valuation based on these changes.

The present disclosure also provides such a method and system in which data is gathered from various sources, entity valuations are calculated, areas for improvement are selected based on the calculations, available benchmarks are factor into the calculations, and objective and/or entity specific criteria determined.

### BRIEF DESCRIPTION OF THE DRAWINGS

FIG. 1 is a flow chart illustrating an embodiment of how data is acquired, stored, calculated, displayed and adjusted.

FIG. 2 is an embodiment of a system architecture used to implement the method and system of the present disclosure.

FIG. 3 is a block diagram of an embodiment of a client computer system used to implement the method and system disclosed herein.

FIG. 4 is a block diagram of an embodiment of a network computer system used to implement the method and system disclosed herein.

FIG. 5 is a flow diagram illustrating another embodiment of how data is acquired, stored, calculated and displayed, based on the method and system disclosed herein.

FIG. 6 is an embodiment of a user interface for a valuation and trend calculator used to implement the method and system disclosed herein.

FIG. 7 is another embodiment of a user interface for a valuation and trend calculator used to implement the method and system disclosed herein.

FIG. 8 is an embodiment of a user interface and drop-down selection menu for selecting comparisons for a valuation and trend calculator used to implement the method and system disclosed herein.

FIG. 9 is another embodiment of a user interface and drop-down selection menu for selecting the order of improvements for a valuation and trend calculator used to implement the method and system disclosed herein.

FIGS. 10A-10G are yet another embodiment of a user interface for a valuation and trend calculator used to implement the method and system disclosed herein.

FIGS. 11A-11G are yet another embodiment of a user interface for a valuation and trend calculator used to implement the method and system disclosed herein, wherein data is obtained from a 10-K form.

### DESCRIPTION OF EXEMPLARY EMBODIMENTS

The present disclosure provides a method and a system for increasing entity value through sustainable productivity growth. Sustainable growth can be achieved through improving gross margins. Improving gross margins can be achieved by selecting areas for improvement based on calculations using collected data, benchmarks and objective and/or entity specific criteria.

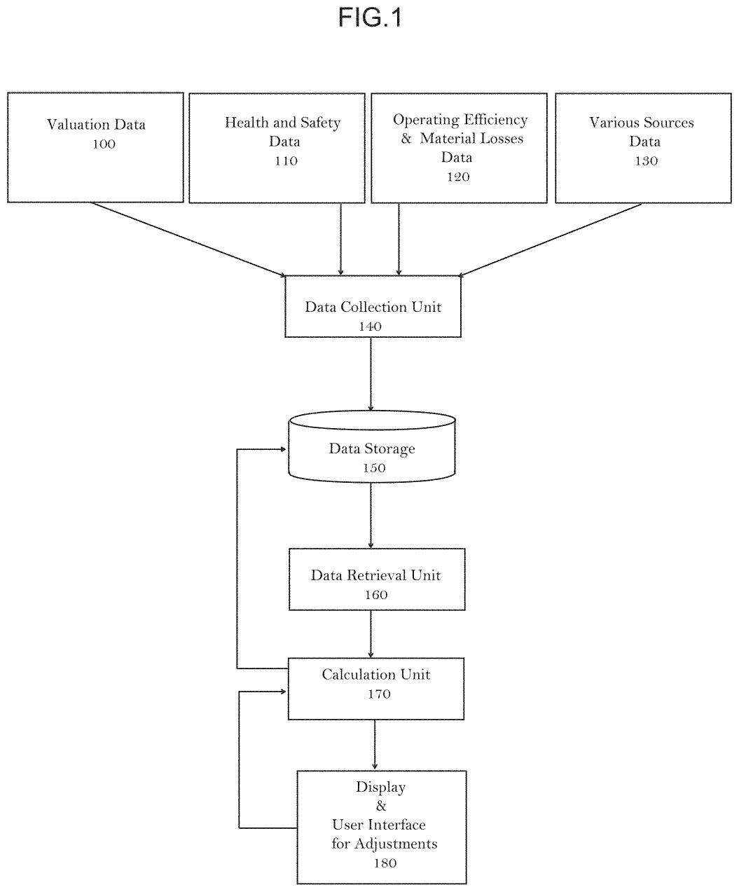

Referring to the drawings and, in particular, to FIG. 1, there is shown a flow chart illustrating an embodiment of how data is acquired, stored, calculated and displayed according to the present disclosure.

Data collection unit 140 collects data from various sources, such as the entity being evaluated, the internet, or third parties. Unit 140 can collect data, via a user interface, or diagnostic questionnaire or other conventional methods.

Data collection unit 140 can be a program module that acquires and stores the data.

The data collected includes valuation data 100, health and safety data 110, operating efficiency data 120, and various source data 130.

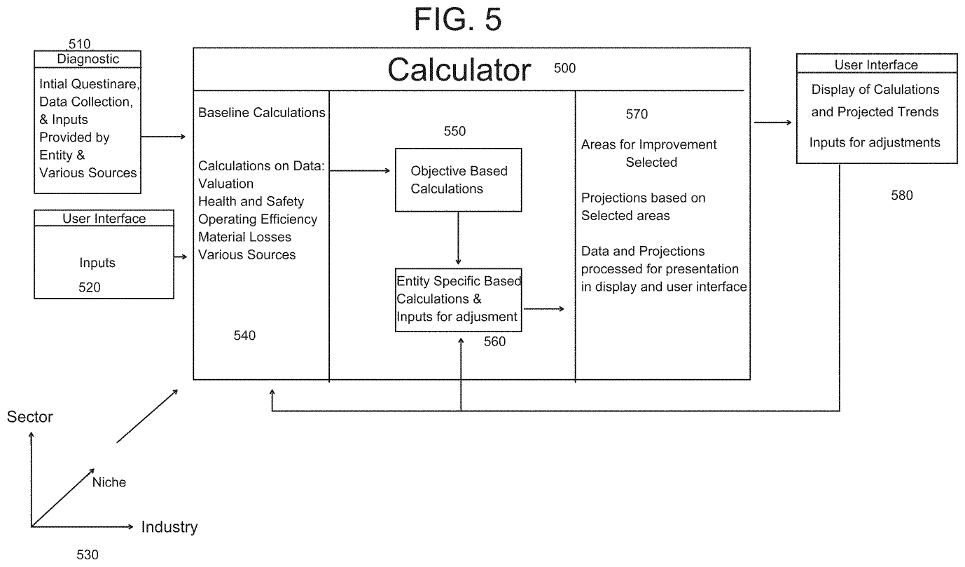

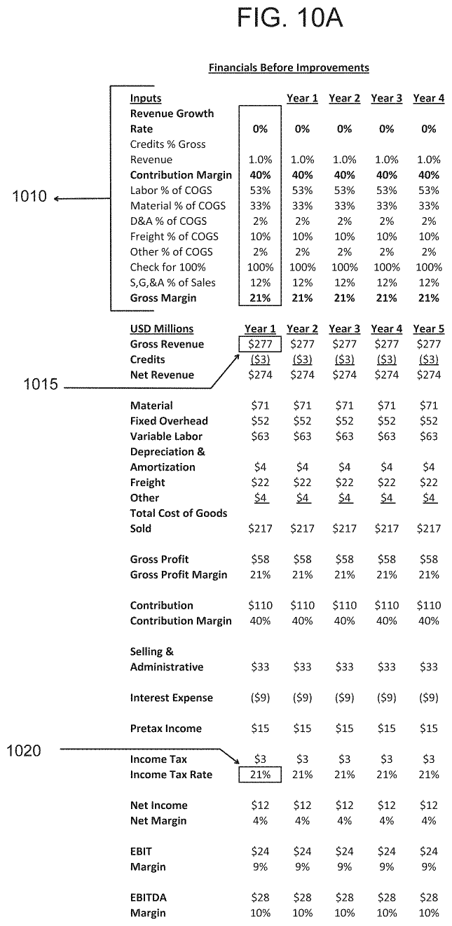

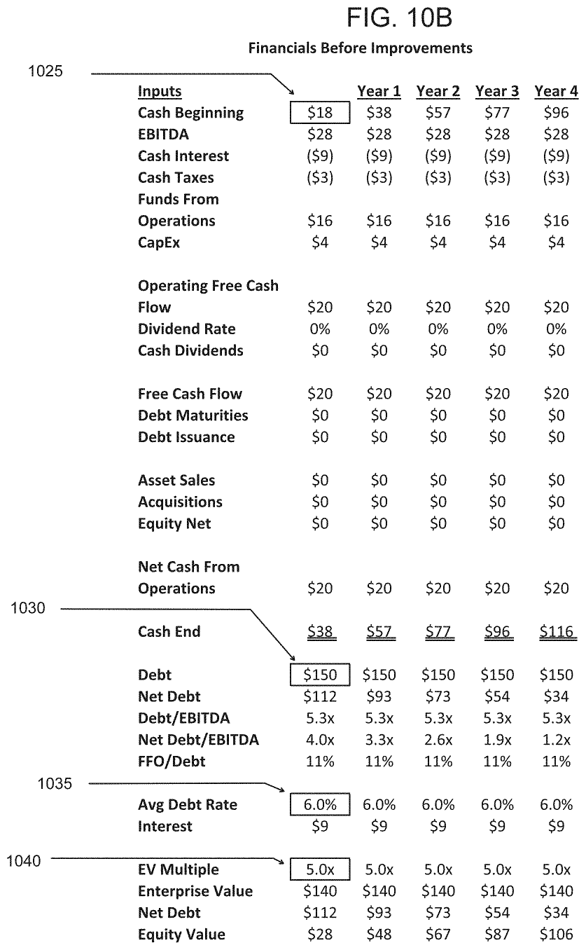

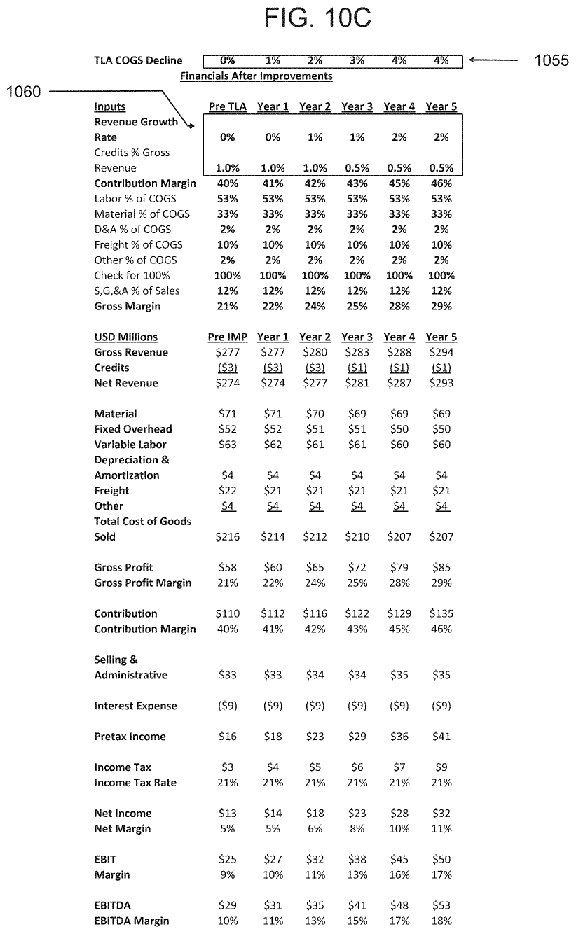

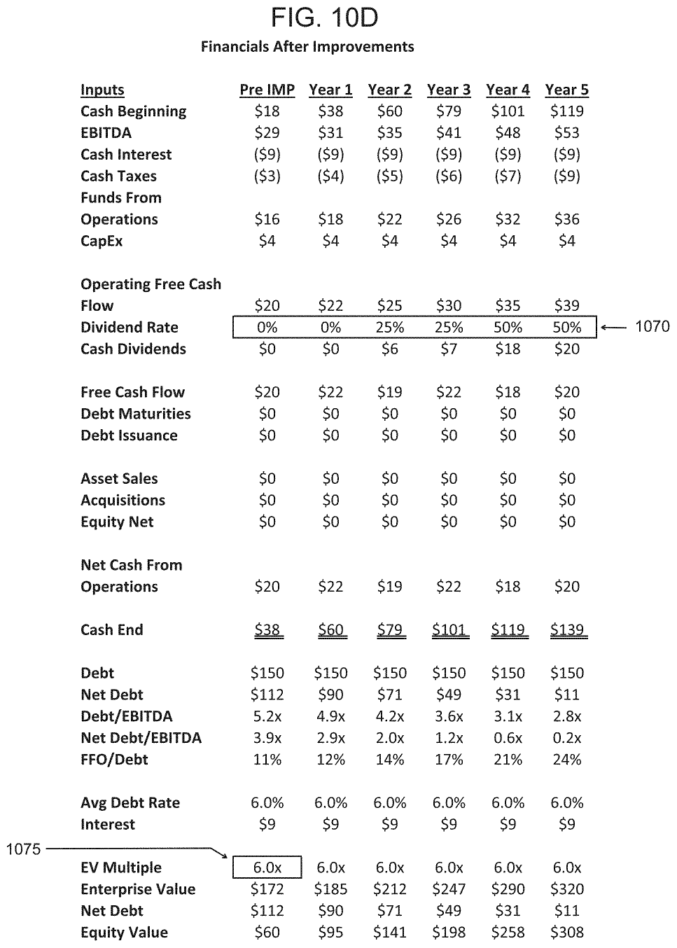

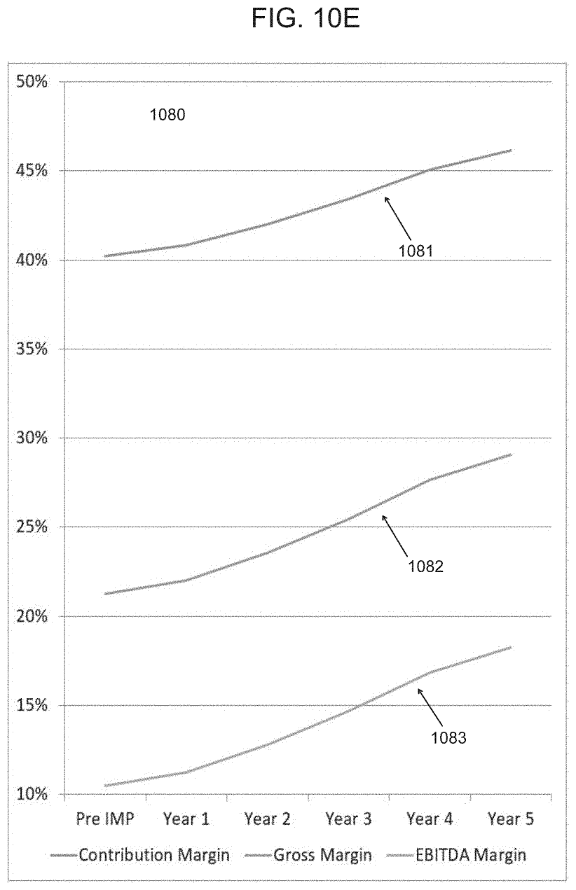

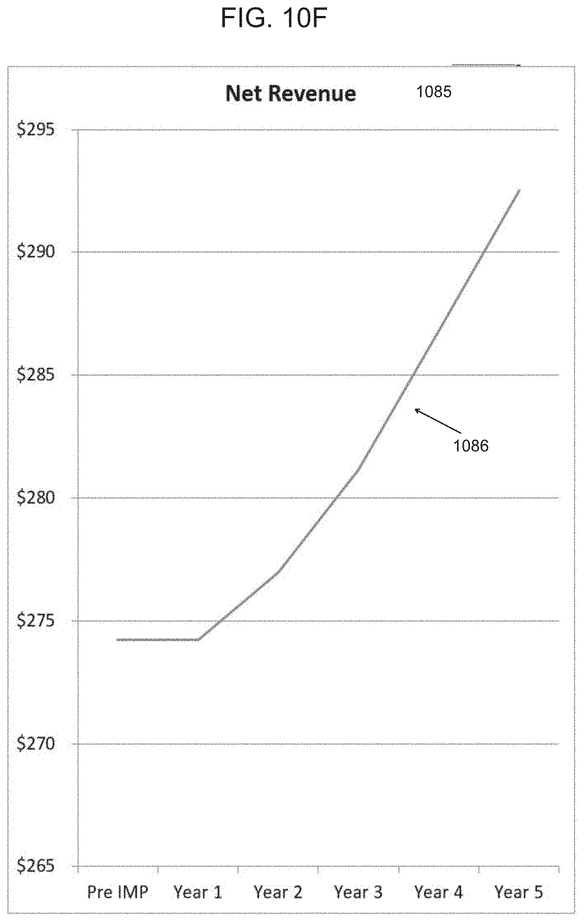

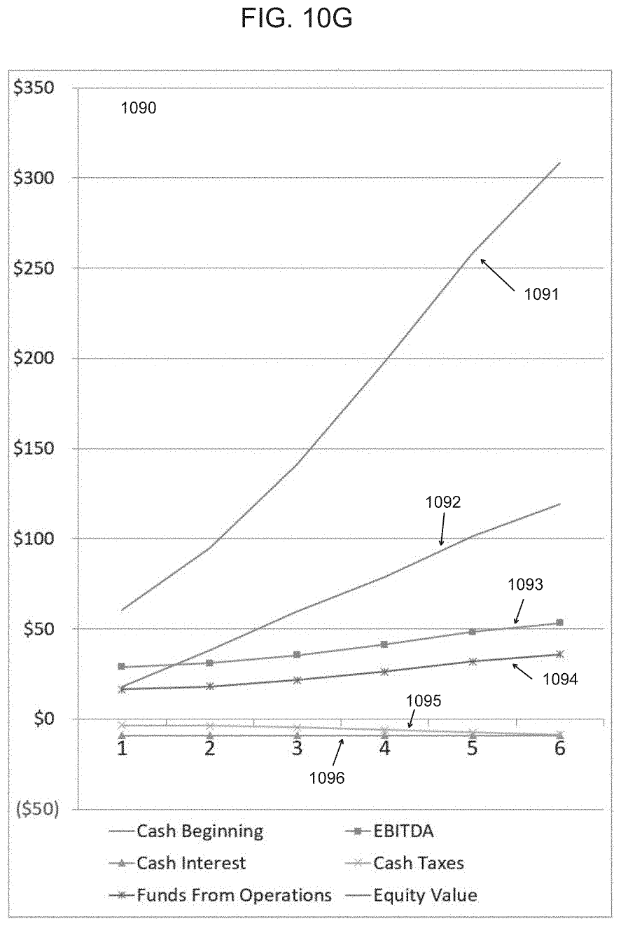

The valuation data 100 is the entity's financial data, such as but not limited to, enterprise value, debt, free cash flow, cost of goods sold, gross and net revenue. The valuation data 100 can be collected directly from the entity, or such as in the case of a publicly traded company, from public records. The valuation data 100 comprises information disclosed on form 10-K reports, as required by the United States Securities and Exchange commission (SEC). Further examples of valuation data 100 includes financial data shown below in calculation unit 170, and FIGS. 5 and 10. Valuation data 100 can include the historic and internal company data of the entity being evaluated. The historic data can include past performance data (Such as but not limited to gross margins and operating efficiencies), and financial data.

Health and safety data 110 is the entity's health and safety data that includes, but is not limited to, the entity's accident reports, risk reports provided to human resources (HR), violations of safety regulations (such as OSHA violations), and resulting fines, including losses of production due to lost labor, time lost, and material.

Operating efficiency and material loss data 120 is the entity's data regarding ideal operating production in comparison to actual production. Machines used in manufacturing production have specifications providing information as to how many goods (goods may comprise an article of manufacture) can be ideally produced by the machine in a given period or amount of time. This metric can be compared to the amount of goods actually produced by the machine during the same period of time, to arrive at the operating efficiency of the machine. Further examples of machine operating efficiency will be provided below in the disclosure of calculation unit 170.

In some embodiments, operating efficiency and material loss data 120 includes data pertaining to the ideal lead time for producing the goods, and/or delivering the goods to an end customer, and the actual time for producing and/or delivering the goods. Operating efficiency and material loss data 120 can further include external failure rates, such as non-compliant or defective goods, or complaints received from customers, and the cost of replacing such non-compliant or defective goods. Operating efficiency and material loss data 120 can also include the percentage of occurrences where ideal lead times match actual lead times.

In some embodiments, operating efficiency and material loss data 120 includes material loss data. Material loss data comprises entity data regarding ideal material loss or material wastage (such acceptable material loss) in comparison to actual material losses during production. Material losses can be measured in weight (for example, the weight of unused materials found on the floor of a production facility). The calculation of material losses can be affected by the reusability of collected material waste in the manufacturing process. In some embodiments, material waste can be reintroduced in the manufacturing process over one or more production cycles. In these embodiments, material waste is reduced each production cycle, and material loss data will reflect this reduction. While it is preferable to re-use material waste, it is more preferable not to have any material waste to begin with.

Various sources data 130 includes miscellaneous data that may be obtained from sources other than the entity being evaluated, such as the internet, third parties, and various public records. Such various source data can include, but is not limited to, benchmark data acquired from and specific to, one or more entities (other than the entity being evaluated) doing business in a particular industry, sector, or niche. The niche category is a subcategory of the sector category, and the sector category is a subcategory of the industry category.

In some embodiments, the benchmark data can be averages or composites of several entities in a particular industry, sector or niche. Benchmark data acquired from entities matching the same industry, sector and niche, as the entity being evaluated are most similar. Benchmark data acquired from entities matching only in industry and sector are less similar. While benchmark data acquired from entities matching only in Industry are the least similar.

In some embodiments, the benchmark data used for comparison with the entity being evaluated, will be the available benchmark data which is most similar.

Various sources data 130 can further include cost of materials, labor, freight (shipping) costs, interest rates, and taxes, particular to the area in which the entity is located, or has manufacturing facilities. The benchmark data can also include the size, and age of the entity or entities from which the data is obtained, for comparison to how similar the benchmark data is to the size and age of the entity being evaluated. In some embodiments, the size of an entity can be measured by the valuation, or number of employees of the entity. In some embodiments, the age of an entity is number of years the entity has been in existence, doing business, and/or the number of years the entity has been formally structured as required by the government in which it resides.

Data collection unit 140 then stores the collected data in data storage 150. Data storage 150 can be a program module for providing instructions on how and where to store the collected data. Data storage 150 can store the data, on various storage mediums, such as, but not limited to, hard drives or databases owned and/or managed by the entity being evaluated, or on storage mediums owned and/or managed by the entity providing the evaluation service, or any combination thereof.

Data retrieval unit 160 retrieves data stored by data storage 150. In some embodiments, data retrieval unit 160 is a program module, for retrieving the data stored by data storage 150. In some embodiments, data retrieval unit 160 can also prompt data collection unit 140 to collect data not initially collected. Data retrieval unit 160 can also prompt data collection unit 140 in the event data is found to be missing. Data retrieval unit 160 supplies the data to calculation unit 170.

Calculation unit 170 performs calculations on the previously collected and stored data. The results of the calculations provide the basis for the selection of areas for improvement, and projected entity valuation and various productivity and projection trends. In some embodiments, calculation unit 170 is a program module for calculating data previously collected and stored. While calculation unit 170 is configured to select or point out an area of improvement, or the indicate the optimal priority in which multiple areas of improvement should be implemented in, a user will be able to view the selections or indications (through a user interface) made by the calculation unit 170, and make the final decision of which area of improvement to implement, or the priority of the implementations, based on the data provided by the calculation unit 170.

Calculation unit 170 can calculate results of the equations listed below, based on the data available in data storage 150. In some embodiments calculation unit 170 can also calculate results based on data received from display and user interface 180 described below. Calculation unit 170 can calculate the results of the equations listed below in seconds, in minutes, and in less preferred embodiments in hours, once calculation unit 170 receives the data from data storage 150.

Calculation unit 170 can use at least the following equations:

Net Revenue=Gross Revenue−Credits

Gross Profit=Net Revenue−Cost of Goods Sold

Cost of Goods Sold=(Material Costs+Overhead Costs+Variable Labor Costs+Freight Costs+Depreciation and Amortization+Miscellaneous Operating costs) (Miscellaneous Operating Costs are consistently defined by the entity).

Net Income=Gross profit−(Selling, General and Administrative Expenses) (+/−) Net Interest Costs (+/−) Other Non-Operating Costs (+/−) Taxes (+/−) Non-Recurring expenses

EBITDA=Gross Profit−(Selling, General and Administrative Expenses)+Depreciation and Amortization (+/−) non-recurring costs

Valuation of Entity (Before Improvements)=EBITDA×Multiplier

Valuation of Entity (After Improvements)=EBITDA×Multiplier

The above Multiplier in some embodiments of the Valuation of Entity Before Improvements is equal to five. The above Multiplier, in some embodiments of the Valuation of Entity After Improvements, is equal to seven, or six. In other embodiments, the Multiplier can be inputted by a user, in both before and after calculations. In other embodiments the multiplier can be obtained from the valuation of the entity (before or after improvements) or the EBITDA (before or after improvements) where the data is available, and/or calculated based on the equations in calculation unit 170.

Contribution=Fixed Overhead+Gross Profit

Contribution Margin=Contribution÷Net Revenue

EBIT=Gross profit−(Selling, General and Administrative Expenses) (+/−) Non recurring costs

EBITDA Margin=EBITDA÷Net Revenue

Interest=Debt×Average Debt Rate

Cash End=Cash Beginning (+/−) Funds from Operations (+/−) Cash Flow from Investing Activities (+/−) Cash Flow from Financing Activities

Net Cash Flow=Free Cash Flow−Debt Maturities+Debt Issuance+Asset Sales−Acquisitions+Equity Net

Free Cash Flow=Operating Free Cash Flow−Cash Dividends

Operating Free Cash Flow=Funds from Operations−Capital Expenditures

Cash Interest=Reported Interest+Non-Cash Portion

Cash Taxes=Reported Taxes (+/−) Non-Cash Portion

Income Tax=(Pretax Income×Income Tax Rate)

Pretax Income=Gross Profit−(Selling, General and Administrative Expenses) (+/−) Non-Operating Costs (+/−) Net Interest Expenses

Net Interest Expense=Interest Expense+Interest Income

Net Income=Pretax Income (+/−) Income tax

Net Margin=Net Income÷Net Revenue

Net Debt=Debt−Cash End

Debt÷EBITDA=Output

Net Debt÷EBITDA=Output

Funds from Operations÷Debt=Output

Equity Value (Before Improvements)=Enterprise Value (Before Improvements)−Net Debt

Equity Value (After Improvements)=Enterprise Value (After Improvements)−Net Debt

Operational Equipment Effectiveness=Non Conformance Metric×Availability Metric×Performance Metric

Non-Conformance Metric is defined as the produced goods that do not meet quality standards as defined by the entity or are defective. Availability Metric is defined as how often the machine is available or unavailable. Performance Metric is defined by the machine's ideal output as defined by its engineered specifications.

In some embodiments gross margin gross profit divided by net revenue.

Additional information may be obtained from the Silgan Holdings Inc. 2017 10-K form, retrieved from: https://www.sec.gov/Archives/edgar/data/849869/000084986918000010/sIgn-2017×1231×10k.htm; and is hereby incorporated by reference. Additional information may be obtained from the 10-K form, as disclosed in the Appendix of U.S. Provisional Application 62/741,984 which is hereby incorporated by reference. While variations to the equations are possible, the equations listed in this disclosure provide a means to quantify improvements.

Once calculation unit 170 obtains the results of the calculations, calculation unit 170 provides the results to display and user interface 180.

In some embodiments, prior to providing the results of the calculations to display and user interface 180, calculation unit 170 further compares the results to benchmarks previously collected by data collection unit 140 and stored in data storage 150. The benchmarks comprise similar financial, valuation, health and safety, operating efficiency and other various sources data pertaining to other entities, (as described above) operating in the same industry, sector or niche as the entity being evaluated.

In some embodiments, the benchmark data will also take into account the size, location and age (as described above) of the entity being evaluated in comparison to the benchmark entity. In these embodiments, the benchmarks used for the comparison will be constrained to benchmarks from entity's similar to the entity being evaluated.

In some embodiments, the comparison of the data of the entity being evaluated to the stored benchmarks can include a variance calculation of the differences between the data of the entity being evaluated, and the benchmark data. In some embodiments, the data with the highest variances, or variances exceeding a predetermined threshold, are selected as areas for improvement by the calculator unit 170.

For example, if the variance between the entity's data and the benchmark is high, or exceeds the predetermined threshold, for the cost of goods, then the cost of goods is selected as an area for improvement.

In some embodiments, where the area selected for improvement comprises multiple sub-areas, the sub-areas are each additionally compared to the comparable benchmark sub-area data. For example, if the cost of goods is selected as the area for improvement, and the cost of goods has sub-areas, such as labor costs, material costs, freight and other miscellaneous costs, these sub-areas of the entity are compared to the sub-areas of the benchmark data. The variance between the entity's material costs, and the benchmark's material costs might have the highest variance of any of the sub-areas, or the variance might exceed a pre-determined threshold. In this case, the material costs are also selected as an area or sub-area for improvement.

In other embodiments, the calculator 170 can select areas for improvement based on criteria separate from the magnitude of the variance between entity data and benchmark data. These criteria can be entered by a user during a diagnostic evaluation, or collected during the data collection phase described above, or be entered via a user interface, as described below after initial results and projections are displayed.

For example, if health and safety is pre-selected by the entity being evaluated, then health and safety will be selected as an area of improvement to be targeted for correction prior to another selected area for improvement, such as the cost of goods.

When one or more areas of improvement are selected, or recommended for improvement, calculator unit 170, can number the areas of improvement. In some embodiments, the first area of improvement is listed as A.O.I (1), and the last area of improvement is listed as A.O.I (n), where (n) is any number of areas of improvement greater than one. The calculator unit 170 can number the areas in various ways, such as but not limited to, the projected financial impact of the area of improvement relative to other areas of improvement. In some embodiments, the areas of improvement with the greater financial impact, or projected resulting increases to entity valuation, will be listed prior to areas with lesser impact. In this embodiment, A.O.I (1) provides greater financial impact when implemented, as compared to A.O.I (n).

Once calculator 170 points out an area for improvement, projected or future trends are calculated for the entity being evaluated. The projected trends include updated valuation data, including but not limited to, updated equity value, lowered cost of goods, and higher gross margins. The projected trends can include results obtainable from any equation utilized by calculation unit 170.

In some embodiments, the calculator 170 will point out areas for improvement that will provide sustainable growth. In these embodiments, the calculator 170 is configured to select areas of improvement that will decrease the cost of goods, and related areas such as material costs, machine operating efficiencies, reduced energy consumption, and improvements to inventory (for example through higher machine efficiencies, less material will need to be purchased to produce the same amount of goods). In some embodiments calculator 170 will select areas for improvement to machine operating efficiencies, that result in decreased inventory needs, reduced maintenance for the machines, and reduction in the need for spare parts. In some embodiments, calculator 170 assumes an eight to twelve percent decrease in the cost of goods based on various improvements related to sub-areas of the cost of goods described above. In some embodiments, calculation unit 170 can provide a presentation of historic data or internal data collected by the collection unit 140. This data can include but is not limited to past performance, or financial data prior to any improvement being implemented. The calculation unit 170 can provide a plot-line diagram to display the data on a user interface such as interface 180.

Advantageously, through decreased costs of producing goods, higher gross margins can be obtained, which in turn can lead to increases in net income, EBITDA, and Net Cash position, and therefore the entity's valuation.

In some embodiments, the projected or future trends data can include updated projections for any of the financial, health and safety, operating efficiency or various sources data previously collected and stored. In some embodiments, the projected trends can be calculated or predicted based on the benchmark data of other entities in the same industry, sector or niche, which made similar improvements.

In other embodiments, the future trends or projections can be calculated by estimates or calculations provided by the entity being evaluated. In these embodiments, the entity provides data as to the projected impact to future trends based on improvements to selected areas. In this way, areas of improvement specific to the entity can be evaluated. In these embodiments, the calculator unit 170 can prompt the user, through display and user interface 180, to enter data previously not collected. This data is then provided to and subsequently stored in data storage 150. Calculation unit 170 then uses the newly acquired data to update the projections and valuations to be provided to display and user interface 180. The updated calculations and projections are also provided to and stored in data storage 150.

For example, the calculator 170 can select operational equipment effectiveness as an area for improvement. In this example, where the machine to be improved can be designed or engineered to meet the needs of the entity being evaluated, the projected impact of the improvements will need to be provided by the entity. For example, the estimated increase in operating equipment effectiveness, which enables more goods to be produced in a given time frame, and projected reductions in the cost of producing the goods, will be provided by the entity.

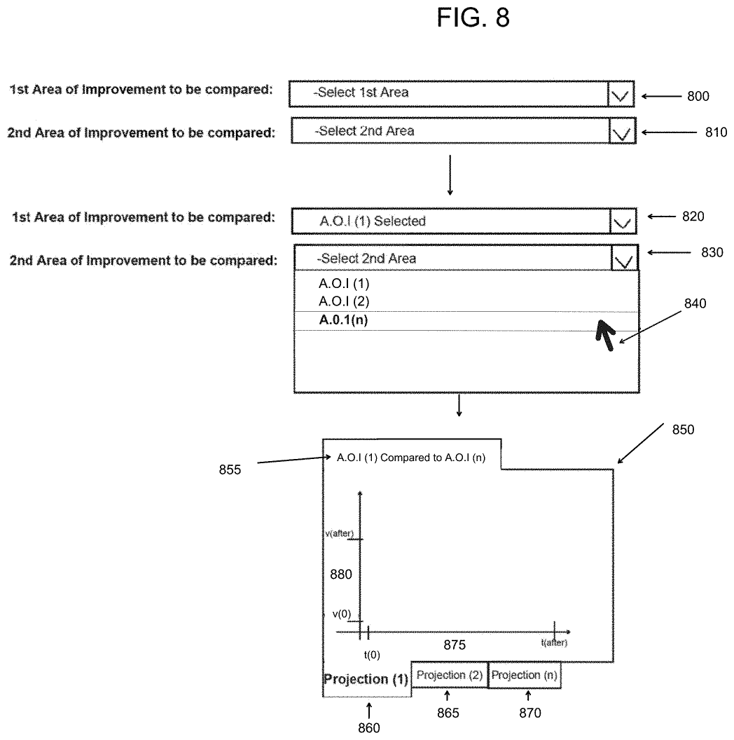

In some embodiments, calculation unit 170 compares selected areas of improvement. The areas for comparison are selected by a user through an interface drop down menu as described below in FIG. 8.

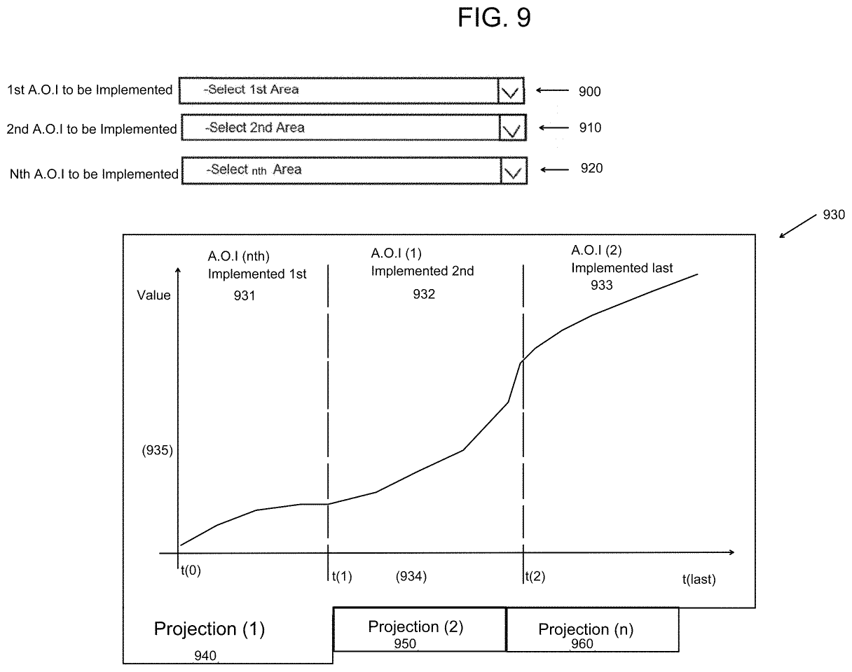

In some embodiments, calculation unit 170 provides projections displaying areas of improvement implemented in various orders selectable by a user through an interface drop down menu as described below in FIG. 9.

In some embodiments, calculation unit 170 provides projections displaying multiple areas of improvement implemented concurrently. In some embodiments the calculator unit can utilize linear and/or non-linear regression to provide estimated, and/or composite projections for multiple areas of improvement implemented concurrently.

Once calculation unit 170 obtains data from data storage 150, and/or calculates the valuation and projected trends for the entity being evaluated, the results and projected trends as displayed by display 180.

Display 180 provides the data and projected trends as part of a user interface. Some embodiments of the user interface are shown in FIGS. 5-10. Some embodiments of the user interface of display 180 are configured to collect data not previously collected and provide such data to data collection unit 140 and/or calculation unit 170. Examples of data not previously collected can include data that must be provided by the entity, in order for trends or projections to be calculated for improvements to areas specific to the entity (such as operational equipment effectiveness data for machines created to specifically for the entity).

In some embodiments, the user interface of display 180 enables the user to change the priority of the selected areas for improvement. These changes and inputs are provided back to the calculation unit 170. Based on the changes to the priority, the projections and trends will be updated.

For example, the calculation unit 170 provides projected trends to the valuation, and productivity growth of an entity over a certain time period, based on selected areas for improvement. During this time period, an entity may have limited resources to implement improvements, especially if multiple areas for improvement are selected and/or recommended by the calculation unit 170. Therefore, it becomes important to choose an area of improvement that will have the largest impact, or the area that is most critical (based on subjective criteria) for that entity.

In some embodiments, when calculation unit 170 receives the changes or inputs from the user interface of display 180, calculation unit 170 conducts updated calculations and projections. Calculation unit 170 may conduct the updated calculations and projections based on information received from the user interface of display 180, or calculation unit 170 may request updated information from data storage 150. Data storage 150 provides the updated information to calculation unit 170 through retrieval unit 160.

In some embodiments, when data storage 150 is unable to find the updated or requested data from calculation unit 170, data storage 150 requests the data from data collection unit 140.

In some embodiments, display and user interface 180 uses interface module 311 and/or 411 as described below, to provide projected data to display 390 and/or 490. In some embodiments, display and user interface 180 receives user inputs from interface 311 and/or 411 as described below, to receive user inputs from input interface 385, and/or 485.

The embodiments described in FIG. 1 are present and implemented in all other embodiments described hereafter.

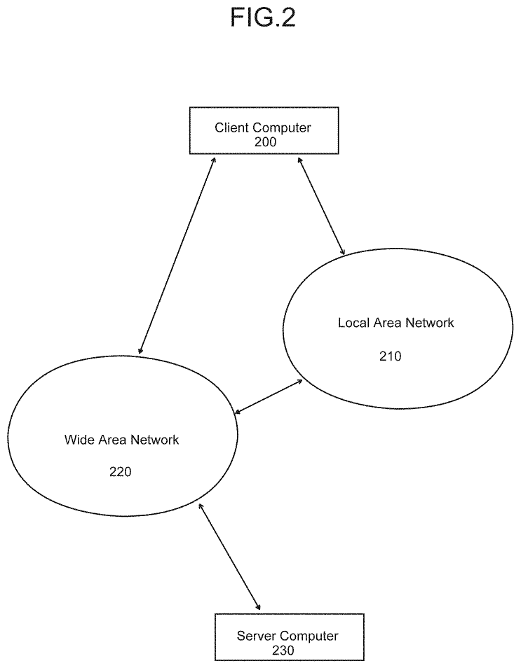

FIG. 2 is an embodiment of a system architecture used to implement the method and system disclosed herein.

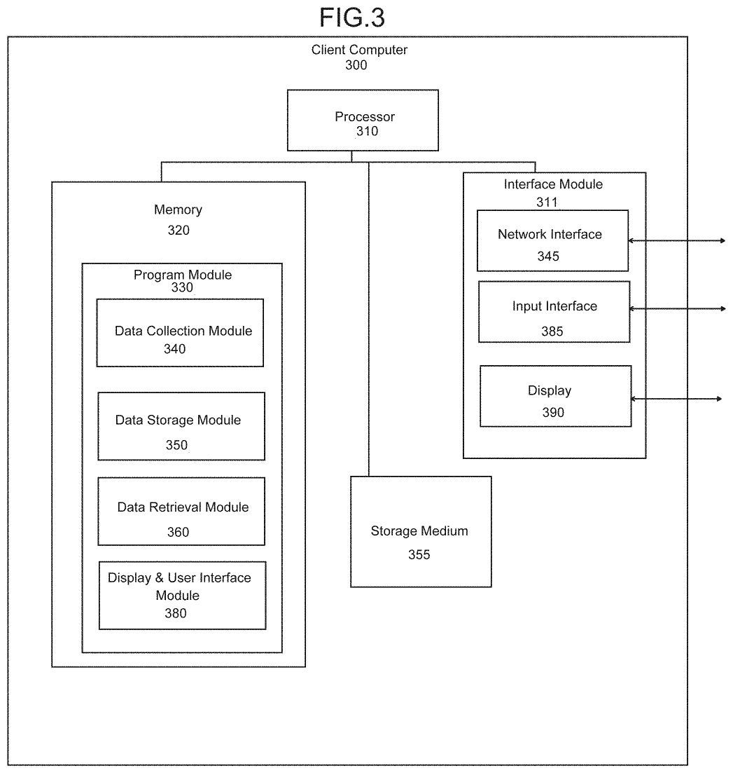

In some embodiments, client computer 200 is the computer or network of computers on which data is collected, and stored, and/or concurrently provided to server computer 230, through use of local area network 210 and/or wide area network 220. Client computer 200 is described in further detail below in FIG. 3.

In some embodiments, client computer 200 is owned and/or under the control of the entity being evaluated.

The data is transmitted over a local area network 210 and/or a wide area network 220. The local area network 210 may be a wireless or wired network. In some embodiments, the wide area network is the internet. Client computer 200 can be directly connected to wide area network 220, or can be connected to network 220, through a local area network 210. Data can also be collected from various sources, and third parties over wide area network 220.

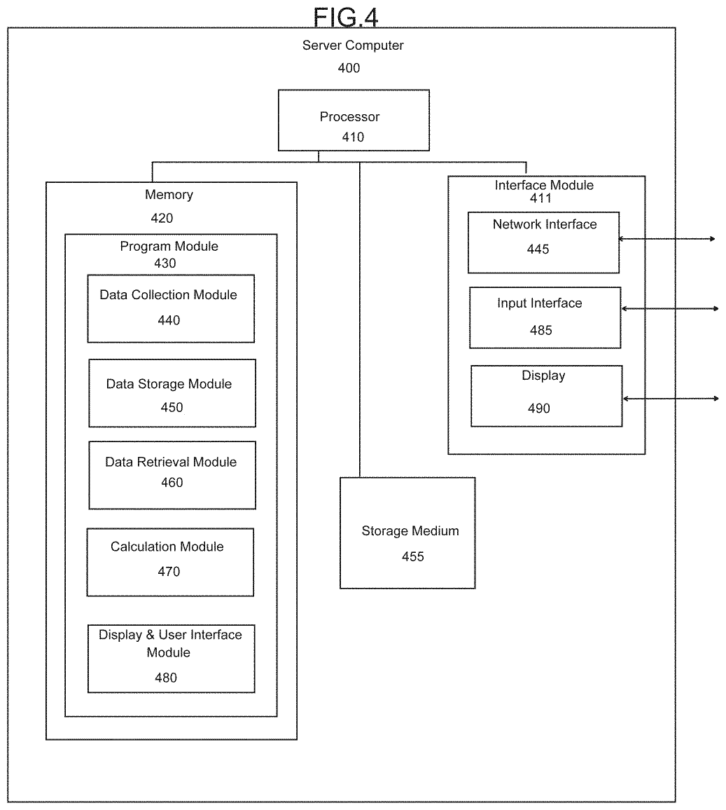

In some embodiments, server computer 230 is a computer or network of computers owned and/or under the control of the entity providing a service comprising the method and system disclosed herein. Server computer 230 is described in further detail below in FIG. 4.

FIG. 3 is a block diagram of a client computer system used to implement the method and system disclosed herein. Client computer 300 includes a processor 310 connected or coupled to a memory 320. Client computer 300 is not limited to a stand-alone device but can be coupled to other devices (not shown) in a distributed computer network or processing system.

Processor 310 is configured logic circuitry that responds to and executes instructions.

Memory 320 is a tangible storage medium that is readable by processor 310. Memory 320 stores data and instructions for controlling the operation of processor 310. Memory 320 can comprise random access memory (RAM), a hard drive, a read only memory (ROM), or any combination thereof. In some embodiments memory 320 is a non-transitory computer readable medium.

Memory 320 contains a program module 330. Program module 330 includes instructions for controlling processor 310 to perform the operations of the data collection module 340, data storage module 350, data retrieval module 360, and display and user interface module 380.

Data collection module 340 can perform all processes as described in data collection unit 140 above. Data storage module 350 can perform all processes as described in data storage unit 150 above. Data retrieval module 360 can perform all processes as described in data retrieval unit 160 above. In some embodiments, memory 320 includes instructions for controlling processor 310 to perform operations of a calculation module (not shown). The calculation module can perform all processes as described in calculation unit 170 above. Display and user interface module 380 can perform all processes as described in display and user interface 180 above.

The program module 330 may be implemented as a single module or as a plurality of modules that operate in cooperation with one another. In some embodiments, program module 330 is installed in memory 320. Program module 330 can be implemented in software, hardware, such as electronic circuitry, firmware, or any combination thereof.

In some embodiments, program module 330 is pre-loaded into memory 320. In other embodiments, program module 330 is configured to be loaded from a storage medium, such as storage medium 355.

Storage medium 355 can include any tangible storage medium that stores program module 330, or any data stored by data storage module 350. Storage medium 355 can include a floppy disk, a compact disk, a magnetic tape, memory sticks, a read only memory, an optical storage media, universal serial bus (USB) flash drive, zip drive, or other type of electronic storage. Storage media 355 can be located on a remote storage system or coupled to client computer 300 via communication network (such as a local or wide area network as disclosed in the description of FIG. 2).

Interface module 311 comprises a network interface 345, an input interface 385, and a display 390.

A communication network can be connected to client computer 300 through network interface 345.

Data collection module 340 can receive data from interface module 311 and/or from storage medium 355, and/or through network interface 345.

Data storage module 350 can then store the data in memory 320, or storage medium 355, or send the data to a server computer through network interface 345, or any combination thereof.

Through instructions provided by memory 320, and in particular, each module, 340, 350, 360, 380, and in some embodiments a calculation unit, processor 310 reads and writes data onto a data storage medium such as 355. The storage of calculated data, and projection trends from a calculation unit on a client and/or server computer onto a storage medium such as 355, enables these stored calculations or projections to be used in future calculations or projections based on updated data, inputs or instructions received at a future time. In this way, the client and/or server computer is modified to perform operations and tasks that the client and/or server computer was previously incapable of performing or completing. Also in this way, the performance and functions of a client and/or server computer is improved.

Data retrieval module 360 retrieves data stored by data storage module 350. Data retrieval module 360 can retrieve data from memory 320, storage medium 355, or any other storage medium accessible through network interface 345.

In some embodiments, data retrieval module 360 can supply data to a calculator module stored on memory 320.

Display and user interface module 380 receives data from a calculator module stored in the memory of a server computer. In this embodiment, module 380 receives the data through network interface 345. Interface module 380, in some embodiments, receives data from a calculator module stored on memory 320 of the client computer 300.

Display and user interface module 380 configures the data from the calculator module for display on display 390. Module 380 displays a user interface on display 390. Some embodiments of the user interface are shown in FIGS. 5-10.

A user can input data into the user interface shown on display 390, through input interface 385. Input interface 385 can include, but is not limited to, a mouse and keyboard, USB, scanner or other input device.

In some embodiments, display and interface module 380 receives the data from input interface 385, and provides the data to data storage module 350, and/or a calculator module stored on the memory of either client computer 300 or a server computer through network interface 345.

Referring to FIG. 4, server computer 400 includes a processor 410 coupled to a memory 420. Server computer 400 is not limited to a stand-alone device, but can be couple to other devices (not shown) in a distributed computer network or processing system.

Processor 410 is configured with logic circuitry. The logic circuitry responds to and executes instructions.

Memory 420 is a tangible storage medium that is readable by processor 410. Memory 420 stores data and instructions for controlling the operation of processor 410. Memory 420 can comprise random access memory (RAM), a hard drive, a read only memory (ROM), or any combination thereof. In some embodiments memory 420 is a non-transitory computer readable medium

Memory 420 contains a program module 430. Program module 430 includes instructions for controlling processor 410 to perform the operations of the data collection module 440, data storage module 450, data retrieval module 460, and display and user interface module 480.

Data collection module 440 can perform all processes as described in data collection unit 140 above. Data storage module 450, is capable of performing all processes as described in data storage unit 150 above. Data retrieval module 460 can perform all processes as described in data retrieval unit 160 above. In some embodiments Memory 420 also includes instructions for controlling processor 410 to perform operations of a calculation module 470. The calculation module 470 can perform all processes as described in calculation unit 170 above. Display and user interface module 480 can perform all processes as described in display and user interface 180 above.

The program module 430 can be implemented as a single module or as a plurality of modules that operate in cooperation with one another. In some embodiments, program module 430 is installed in memory 420, and can be implemented in software, hardware, such as electronic circuitry, firmware, or any combination thereof.

In some embodiments, program module 430 is pre-loaded into memory 420. In other embodiments, program module 430 can be configured to be loaded from a storage medium such as storage medium 455.

Storage medium 455 can include any tangible storage medium that stores program module 430, or any data stored by data storage module 450. Storage medium 455 can include a floppy disk, a compact disk, a magnetic tape, memory sticks, a read only memory, an optical storage media, universal serial bus (USB) flash drive, zip drive, or other type of electronic storage. Storage media 455 can be located on a remote storage system, or coupled to Server computer 400 via communication network (such as a local or wide area network as disclosed in the description of FIG. 2).

Interface module 411 comprises a network interface 445, an input interface 485, and a display 490. A communication network can be connected to server computer 400 through network interface 445.

Data collection module 440 can receive data from interface module 411 and/or from storage medium 455, and/or through network interface 445.

Data storage module 450 can then store the data in Memory 420, or storage medium 455, or sends the data to a client computer through network interface 445, or any combination thereof.

Through instructions provided by memory 420, and in particular, each module, 440, 450, 460, 470, and 480, processor 410 reads and writes data onto a data storage medium such as 455. The storage of calculated data, and projection trends from a calculation unit on a client and/or server computer onto a storage medium, such as 455, enables these stored calculations or projections to be used in future calculations or projections based on updated data, inputs or instructions received at a future time. Accordingly, the client and/or server computer is modified to perform operations and tasks that the client and/or server computer was previously incapable of performing or completing. Therefore, the performance and functions of a client and/or server computer is improved.

Data retrieval module 460 retrieves data stored by data storage module 450. Data retrieval module 460 can retrieve data from memory 420, storage medium 455, or any other storage medium accessible through network interface 445.

In some embodiments, data retrieval module 460 can supply data to calculator module 470 stored on memory 420. In some embodiments, calculator module 470 can send baseline calculations, areas selected for improvement, and projections (or any other data capable of being provided by calculation unit 170) to a storage medium such as 355, or the display and user interface module 380 or interface module 311 of a client computer 300.

Interface module 480, in some embodiments, receives data from a calculator module stored on memory 420 of the server computer 400.

Display and user interface module 480 configures the data from the calculator module 470 for display on display 490. Module 480 displays a user interface on display 490. Some embodiments of the user interface are shown in FIGS. 5-10.

A user can input data into the user interface shown on display 490, through input interface 485. Input interface 485 can include, but is not limited to, a mouse and keyboard, USB, scanner or other input device.

In some embodiments, display and interface module 480 receives the data from input interface 485, and provides the data to data storage module 450, and/or a calculator module, or display or interface module 380, or interface module 311 of a client computer 300 through network interface 445.

FIG. 5 illustrates an embodiment of how data is acquired, stored, calculated, updated, and displayed, according to the method and system disclosed herein. Diagnostic 510 can include an initial questionnaire, the answers to which are provided by the entity being evaluated. The initial questionnaire can include questions relating to financial, machine operating efficiency, health and safety, material losses, data used in calculations conducted by the calculation unit 170, and/or calculation unit module 470 described above. Various sources data can be obtained from the entity or other sources as described above. In some embodiments, the diagnostic can include any data collected in the data collection phase, by data collection unit 140, data collection module 340, and 440 described above. Once the diagnostic 510 and data collection is complete. the data is provided to the calculator 500.

Interface 520 enables the same data collected by diagnostic 510 to be entered. Interface 520 comprises interface modules 311 and 411 as described above and in FIGS. 3-4. The interface 520, in some embodiments, is a user interface window through which a user can enter in data, through various input interfaces (such as a mouse, keyboard, scanner). The interface 520 provides the data to calculator 500.

Industry, sector and niche data 530 is benchmark data pertaining to other entities in the same industry, sector, or niche (or any combination thereof) as the entity being evaluated. Data 530 can be obtained through the data collection phase described above, or through diagnostic 510, or through interface 520, or through data collection unit 140, or data collection module 340 and/or 440, or any combination thereof. In some embodiments, data 530 can be provided by the entity providing the evaluation service. Further description of benchmark data 530 can be found in the description of benchmark data described in the discussion of calculator unit 170 above. Benchmark data 530 is provided to calculator 500.

Calculator 500 then uses the data provided by diagnostic 510, interface 520, and benchmark data 530, to conduct baseline calculations 540. The baseline calculations 540 can comprise baselines on entity valuation, health and safety parameters, machine operating efficiencies, material losses and various sources data at the time of collection. Further description of the calculations can be found in present disclosure of calculator unit 170 described above.

Calculator 500 then uses the baseline calculations to identify and select areas for improvement, to be targeted for corrections by the entity being evaluated.

In some embodiments, calculator 500 conducts objective based calculations 550, using the provided benchmark data 530, as a comparison to the baseline calculations. Based on variances between the baseline calculations and benchmark data, calculator 500 selects an area for improvement using objective criteria at 550. Further description of the calculations and utilization of benchmark data 530 can be found in the disclosure of calculator unit 170 described above.

In some embodiments, calculator 500 further conducts entity specific based calculations 560 in order to select areas for improvement. In some embodiments, calculator 500 conducts the entity specific calculations 560, after the objective based calculations 550. In these embodiments, the areas for improvement initially selected using objective based calculations 550, are adjusted by entity specific calculations 560.

The data for the entity specific calculations can be obtained from the diagnostic 510, or the interface 520, or the interface 580 (described below), or any combination thereof.

In some embodiments, the entity specific calculations 560 are not conducted until the baseline calculations 540 and objective based calculations 550 are used to select an area for improvement, and the area of improvement is used to create projections for display on interface 580. Once the user views the data and projections provided for display at 580, the user can make adjustments and enter in new data at interface 580. In these embodiments, calculator 500 receives data from interface 580 to be used in the entity specific calculations 560.

Once objective based calculations 550, and/or entity specific based calculations 560 are completed, areas for improvement are selected at 570. Based on the selected areas for improvement, projections to various values (such as but not limited to gross margin, net revenue, EBITDA, and entity valuation) are calculated, and processed for presentation on a display as part of interface 580. The data sent to interface 580 can include the baseline calculations, and values before and after improvements. Further details on how areas for improvement are selected, were discussed above with calculation unit 170.

Interface 580 receives data from calculator 500, such as the selected areas of improvement and projected data from 570. Interface 580 presents the data, areas selected for improvement, and provides the user the ability to input data previously not collected, and/or make adjustments to the areas of improvement selected by calculator 500. These inputs and adjustments are then provided to calculator 500, and used by the calculator to make adjustments to the selected areas of improvement and projections. In some embodiments, the data and adjustments entered into interface 580, are provided to calculator 500, during the entity specific based calculations 560.

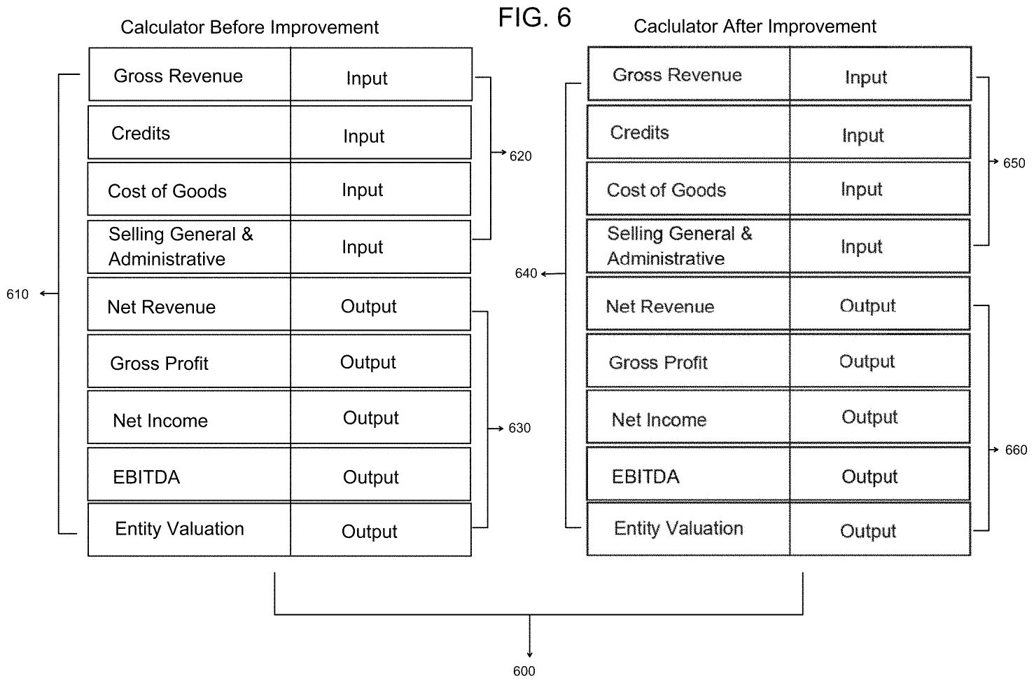

FIG. 6. is an embodiment of a user interface for a valuation calculator used to implement the present method and system. Calculator 600 comprises a before improvement calculator 610, and an after improvement calculator 640.

Before improvement calculator 610 is an interface. It interfaces with the calculator in calculation unit 170, calculator unit module 470, or calculator 500, or any combination thereof. Calculator 610 provides an interface for inputs 620.

Inputs 620 are provided by the entity being evaluated, or collected during the data collection phase, before an improvement or improvements are implemented. In some embodiments, inputs 620 comprise gross revenue, credits, cost of goods, and selling, general and administrative expenses.

Based on the inputs 620, calculator 610 uses processes, such as those described above in calculation unit 170, to provide outputs 630. Output 630 provides baseline calculations before any improvement or improvements are implemented for any values, such as but not limited to, gross profit, net income, EBITDA, and entity valuation.

After improvement calculator 640 is also an interface for the calculator in calculation unit 170, calculator unit module 470, or calculator 500, or any combination thereof. Calculator 640 provides an interface for inputs 650.

Inputs 650, like inputs 620, are provided by the entity being evaluated, or collected during the data collection phase, after a particular improvement is implemented. In some embodiments, inputs 650, like inputs 620, comprise gross revenue, credits, cost of goods, and selling, general and administrative expenses.

Based on the inputs 650, calculator 640, uses processes such as those discussed above in calculation unit 170, to provide outputs 660. Outputs 660, like outputs 630, provides baseline calculations for values, such as but not limited to, gross profit, net income, EBITDA, and entity valuation, after a particular improvement or improvements are implemented

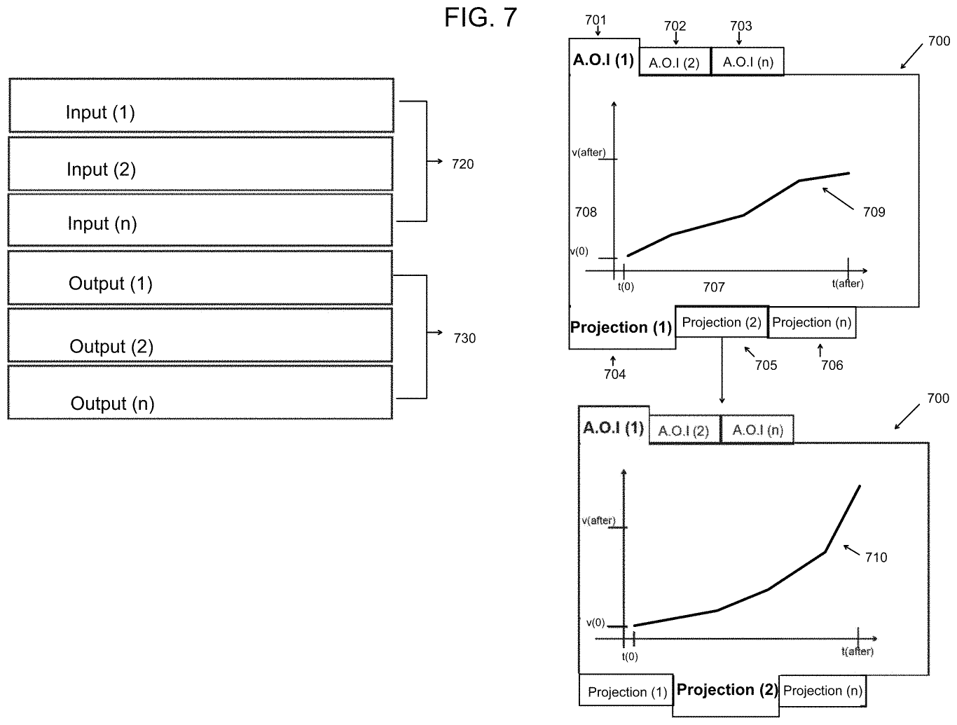

FIG. 7 is another embodiment of a user interface for a valuation and trend projection calculator used to implement the present method and system. Interface 700 provides projected trends based on selected areas of improvement. The areas of improvement are selected, as described above, in calculation unit 170, calculation module 470, calculator 500, or any combination thereof.

The projected trends can be any value that calculator unit 170 can produce based on data provided by the entity being evaluated and/or data collected during the data collection phase, as described above. For example, projected trends can show projections over a period of time for values, such as but not limited to, gross margins, EBITDA, net income, entity value, and cost of goods.

Interface 700 has selectable tabs 701, 702, and 703, which can each be selected by the user. Tabs 701, 702, and 703 represent areas of improvement (A.O.I) selected by the calculator. Tab 701 represents a first area of improvement (A.O.I (1)). Tab 702 represents a second area of improvement (A.O.I(2)). Tab 703 represents an nth area of improvement (A.O.I (n)), where the value of the nth area, may be any number of areas of improvement after the first area of improvement. In some embodiments, the nth area is the last area of improvement. As discussed above, the areas of improvement from first to last, can be ordered in various ways. In some embodiments, the areas of improvement ordered first are of greater financial impact or produce greater sustainable growth than areas ordered later or last. Again, interface 700 can have any number of tabs representing any number of areas of improvement been the first area of improvement shown in tab 701 through the last or nth area of improvement displayed by tab 703.

Each area of improvement 701, 702 and 703 has one or more projections, which can be selected by a user. Tabs 704, 705 and 706 represent the projections. Tab 704 represents a first projection, tab 705 represents a second projection, and tab 706 represents an nth projection, where the nth projection may be any number of projections after the first projection.

Interface 700 illustrates a projection 709 when the first projection tab 704 is selected. Projection 709 is provided on a time axis 707, and a value axis 708. Time axis 707 can be presented in seconds, minutes, hours, days, months, fiscal quarters, years, or any other interval of time as needed, and/or in order to provide a clear presentation of projection 709.

Time axis 707 has several time points. An initial time t(0) is a time at which improvements are first implemented. t(before) is the time before an improvement is implemented and t(after) is a time after an improvement is implemented and thus after t(0). The time intervals used by axis 707 can be adjusted by the user.

Value axis 708 can be in any unit needed to represent projection 709, or other projections displayed by tab 705 and/or tab 706. In some embodiments, value axis 708 is measured in any global currency, such as United States Dollars.

For example, in some embodiments, tab 701 is selected by the user to display data relevant to a first selected area of improvement. The selected area of improvement is the cost of goods. Projection tab 704 shows projection 709 displaying data relevant to the first area of improvement. In this example, projection tab 704 represents a projection for gross margin increases, should improvements to the cost of goods (A.O.I(1)) be implemented. Each selected area of improvement (in this example for the cost of goods) can have multiple projections. Tab 705 and 706 would show additional projections for the same area of improvement to the cost of goods.

Projection 710 shows a projection for net revenue increases should the same improvements to the cost of goods be implemented. Projection 710 is displayed when the user selects tab 705 for the second projection.

In some embodiments, the projections displayed in interface 700 can be obtained from the data collection phase or diagnostics. The data can also be obtained from a user interface, such as input interface 720. Input interface 720 can comprise a first input, a second input and any number of inputs after the first input, such as input (n). Inputs for input interface 720 are provided by the entity being evaluated, or collected during the data collection phase, before and/or after a particular improvement or improvements are implemented. In some embodiments, inputs 720 comprise gross revenue, credits, cost of goods, and selling, general and administrative expenses. In some embodiments, additional input interfaces allow input of data collected after one or more areas of improvement to are implemented.

In some embodiments, based on the inputs 720, the calculator uses processes in calculation unit 170, calculator module 470 or calculator 500, to provide outputs 730. Outputs 730 provide calculations for values, such as but not limited to, gross profit, net income, EBITDA, and entity valuation, before and/or after a particular improvement or improvements are implemented. Output interface 730 can comprise a first output, second output and any number of outputs after the first output, such as output (n).

FIG. 8 is another embodiment of a user interface for selecting comparisons of areas of improvement. Interface 800 is a drop-down menu used to select a first area of improvement to be compared to a second area of improvement. Interface 810 is a second drop-down menu used to select a second area of improvement to be compared to a first area of improvement.

Interface 830 has the drop-down menu of interface of 810, where an input device, such as a mouse pointer 840, is used to select the second area of improvement to be compared. Interface 820 has the drop-down selection menu for selecting a first area of improvement for comparison, as it would appear after a selection is made. Interface 820 also has the first area of improvement selected for comparison as A.O.I(1) (Abbreviation for Area of Improvement 1). Interface 830 has the process of selecting the second area of improvement using an input device, such as mouse pointer 840 and shows the second area for improvement selected for comparison is A.O.I (n) (Abbreviation for Area of Improvement n). Area of improvement (n) can be any number of areas (n) of improvement after the first area of improvement.

Interface 850 displays the selected first area of improvement selected compared to a selected second area of improvement. Interface 850 has an interface where the first area selected is A.O.I(1), and the second area selected is A.O.I (n), as shown in interface 820 and 830 respectively.

In some embodiments, interface 850 has a tab 855 for displaying data, such as the names of the areas of improvement selected for comparison. In some embodiments, interface 850 has tabs 860, 865 and 870 for selecting various projections, such as projection (1), projection (2) and projection (n), respectively.

The projected trends can be any value that calculator unit 170, calculator module 470, or calculator 500 is capable of producing, based on data provided by the entity being evaluated and/or data collected during the data collection phase described above. For example, projected trends can show projections, over a period of time for values, including but not limited to, gross margins, EBITDA, net income, entity value, and cost of goods sold.

Tab 860 selects a first projection, tab 865 selects a second projection, and tab 870 selects an nth projection. The nth projection can be any number of projections (n) after the first projection. For example, tab 860 can represent the gross margin projection, tab 865 can represent entity valuation, and the number of projections and tabs for selecting the projections can increase until the nth projection of tab 870.

In some embodiments, interface 850 provides a time axis 875, and a value axis 880. Time axis 875, is capable of being presented in seconds, minutes, hours, days, months, fiscal quarters, years, or any other interval of time as needed, and/or in order to provide a clear presentation of the comparison of the areas of improvement.

Time axis 875 has several time points. An initial time t(0) is a time at which improvements are first implemented. t(before) is the time before an improvement is implemented and t(after) is a time after an improvement is implemented and thus after t(0). The time intervals used by axis 875 can be adjusted by the user.

Interface 850 can provide comparisons of the areas of improvement selected for comparison in various ways. In some embodiments, the difference in the values of the first area of improvement in relation to the second area of improvement, for any given time or value, are shown as a projection on interface 850. In some embodiments, interface 850 compares the difference in values of the selected first and second areas of improvement, at a time such as t(before), t(0), or t(after), or any combination thereof. In some embodiments, the area beneath the curve or projection of the first area of improvement is compared to the area beneath the curve or projection of the second area of improvement.

Advantageously, the use of the interfaces as described in FIG. 8, enable a user to quickly select various areas of improvement for comparison. Once the comparisons are provided by interface 850, a user can select tabs, such as 860, 865 and 870, to display various projections to be compared. For example, the tab 860 can show the comparisons for the projected increases in gross margins for the first area of improvement selected in interface 820 as compared to the second area of improvement as selected in interface 830. Tab 865 can show the comparisons for EBITDA, net income or other projections or areas of interest. In some embodiments, once the areas of improvement are selected for comparison through the use of the interfaces, the calculation unit 170, calculator module 470, or calculator 500, can return comparisons for display on interface 850, within seconds or minutes. In some less preferred embodiments, calculation unit 170 can return comparisons for display on interface 850 within hours.

Based on the results of the comparison, a user can quickly make decisions as to which area of improvement to implement, based on the results or indications provided by the calculation unit, and shown on the user interface. Concerns can arise when multiple areas of improvement are viable, but an entity has limited resources or time in which to implement the improvements. Interface 850 provides vital information, in a clear visual format in seconds or minutes, which enables users to make informed decisions on implementing various improvements with confidence and speed.

FIG. 9 is an embodiment of a user interface for selecting the order of which areas of improvement are implemented. Interface 900 is a drop-down menu for selecting the area of improvement to be implemented first. Interface 910 is a drop-down menu for selecting the area of improvement to be implemented second. Interface 920 is a drop-down menu for selecting the area of improvement to be implemented in the nth order. In some embodiments, the number of drop down menus, such as shown by interface 900 and 910, correspond to the number of areas of improvement (n). In these embodiments the number of selectable areas of improvement capable of being ordered, correspond to the number of areas of improvement (n). It should be understood that the menus can be any menus, not just drop down menus. However, drop down menus are preferred.

As described above, the calculator unit 170, calculator module 470, or calculator 500 provide selected areas of improvement for implementation. Where more than one area of improvement is provided, the areas of improvement can be placed in any order as described above.

The sequence in which areas of improvement are capable of being ordered, is distinct from the number of areas of improvement selected by the calculator, as described above. The total number of areas of improvement (n), selected by the calculator, can be arranged or implemented in any number of orders (n).

Interface 930 shows an embodiment in which the nth area of improvement (A.O.I (n)) is selected to be implemented first, the first area of improvement (A.O.I(1)) is selected to implemented second, and the second area of improvement (A.O.I(2)) is selected to be implemented last. In some embodiments, interface 930 can display any number of orders of implementing various areas of improvement, up to and including the nth area of improvement.

Interface 930 displays projections showing the order of the first area of improvement to be implemented 931, the second order 932 and the last order 933. Various projections displaying the same order of implementation chosen by the user can be shown by selecting tab 940, 950 and 960 for the first, second and nth projections, respectively. Interface 930 shows a first projection displayed by selection of tab 940.

In some embodiments, interface 930 provides a time axis 934, and a value axis 935. Time axis 934 can be presented in seconds, minutes, hours, days, months, fiscal quarters, years, or any other interval of time as needed, an/or in order to provide a clear presentation of the areas of improvement. In some embodiments, time axis 934 has an initial time, t(initial) or t(0), such that t(initial) or t(0) is the time at which an improvement is first implemented. Time axis 934 can also have a time, t(after), such that t(after) is the time after an improvement is implemented. In some embodiments, time axis 934 can include a time t(before), such that t(before) is a time before the improvement is implemented.

In some embodiments, the time interval between t(0) and t(1) represents the time in which the first area of improvement 931 is implemented. The time interval between t(1) and t(2) represents the time in which the second area of improvement 932 is implemented. The time interval between t(2) and t(last) represents the time in which the last area of improvement 933 is implemented. The time intervals used by time axis 934 can be adjusted by the user. For example, the time intervals between the areas of improvement can be set to be equal or varying amounts of time. Value axis 935 may be in any unit needed to show the selected areas of improvement. In some embodiments, value axis 935 is measured in any global currency, such as United States Dollars.

As discussed above, calculation unit 170, calculation module 470, or calculator 500 selects areas of improvement. When more than one area of improvement is available to be selected, a user can select the order in which the improvements are implemented. The calculation unit then provides projections for each subsequent area of improvement to be implemented, after the first improvement, based on the last time and value coordinates calculated for a preceding area of improvement.

For example, the first area of improvement 931 selected by the user to be implemented is the nth area of improvement. In this example, area 931 is selected first in drop-down menu 900, and can consist of improvements to health and safety. The second area of improvement 932 selected is A.O.I(1), selected to be implemented second in drop-down menu 910, and can consist of improvements to the cost of goods. The last area of improvement 933 selected is A.O.I(2), selected to be implemented last in drop-down menu 920, and can consist of improvements to machine operating efficiencies. Tab 940 is presently selected as illustrated by interface 930. In this example, projection (1) of tab 940 displays projections for improvements to the gross margin. If tab 950 is selected, improvements to the entity's value can be displayed on interface 930. In this example, the starting value and time of the second area of improvement 932 begins using the same terminal value and terminal time of the preceding area of improvement 931. In this example, the terminal time and starting time are t(1). The terminal value and starting value are the values corresponding to t(1). The starting value, and starting time of the last area of improvement 933, are calculated in the same manner. In this example, health and safety area 931 has the least increase in value, while cost of goods area 932 has the highest increase in value. However, the user has chosen to implement improvements to health and safety before improvements to the cost of goods, as it is important to this user.

In some embodiments, multiple areas of improvement are selected to be concurrently implemented. In some embodiments, the calculation unit 170, calculator module 470, or calculator 500, can take the sum of each of the projected increases of the selected areas of improvement, to produce a composite projection. In some embodiments, the calculation unit 170, calculator module 470, or calculator 500 can plot various data points from each area of improvement selected on interface 930, and use a linear regression, non-linear regression, or any combination thereof to produce an estimated or composite projection.

Advantageously, the use of the interfaces as described in FIG. 9, enable a user to quickly select the order of implementation of various areas of improvement for comparison. Once the areas of improvement are ordered, calculated and provided by interface 930, a user can select tabs, such as 940, 950, and 960, to display various projections based on the same order selected. For example, the tab 950 shows the order of implementation for various areas of improvement displaying, projections or changes to the gross margin. Tab 960 can show the comparisons for EBITDA, net income or other projections or areas of interest. In some embodiments, once the order of implementation for the areas of improvement are selected by use of the interfaces, the calculation unit 170, calculator module 470 or calculator 500, can return projections based on the selected order for display on interface 930, within seconds or at most minutes. In some less preferred embodiments, calculation unit 170, calculator module 470 or calculator 500 can return projections based on the order selected for display on interface 930 within hours.

Based on the results of the projections to the ordered areas of improvement, a user can quickly make decisions as to which area of improvement to implement, and in which order to do so. Concerns can arise when multiple areas of improvement are viable, but an entity has limited resources or time in which to implement the improvements. Interface 930 quickly provides vital information, in a clear visual format, preferably in seconds or minutes, which enables users to make informed decisions on implementing various improvements with confidence and speed.

FIGS. 10A-10G show another embodiment of a user interface for a valuation and trend calculator used to implement the method and system disclosed herein. Calculator unit 170, calculation module 470, or calculator 500 can produce the values, and graphs and/or projections shown in FIGS. 10E-10G based on the following inputs described below.

COGs is an abbreviation for the cost of goods sold. D&A is an abbreviation for depreciation and amortization. S,G&A is an abbreviation for selling, general and administrative costs. EBIT is an abbreviation for earnings before interest and taxes. EBITDA is an abbreviation for earnings before interest, taxes, depreciation and amortization. CapEx is an abbreviation for capital expenditures. FFO is an abbreviation for funds from operations. Avg is an abbreviation for average. EV is an abbreviation for evaluation. Imp is an abbreviation for improvement.

The calculator interface of FIGS. 10A-10D is divided into a before improvements interface as shown in FIGS. 10A and 10B, and an after improvement interface as shown in FIGS. 10C and 10D. The before improvements Interface shown in FIGS. 10A and 10B provides projections from year one to year five, for an entity that does not make improvements, to various areas, such but not limited to, the cost of goods.

The after improvements interface shown in FIGS. 10C and 10D provides projections from a year before improvements, to years one through five for an entity which makes improvements to areas such as, but not limited to, the cost of goods.

In some embodiments, 1010 provides an interface for inputting a percentage into any one or more of the fields. The input fields can include revenue growth rate, credits percentage of gross revenue, contribution margin, labor percentage of cost of goods, material percentage of cost of goods, depreciation and amortization of cost of goods, freight percentage of cost of goods, other miscellaneous percentage costs that make up the cost of goods, selling general and administrative percentage of the cost of goods and gross margin.

1015 is an interface for inputting a value for the gross revenue, at year one. 1020 is an interface for inputting the income tax rate at year one. 1025 is an interface for inputting cash beginning, or cash available before year one. 1030 is an interface for inputting debt at year one. 1035 is an interface for inputting the average debt rate percentage before year one. 1040 is an interface for inputting the entity valuation multiple. In some embodiments, the valuation multiple can be but is not limited to five, where improvements, such as but not limited to, the cost of goods are not made. In some embodiments the valuation multiple as shown by interface 1040 is chosen or inputted by the user. In some embodiments the valuation multiple can depend on the type of entity being evaluated, and on market conditions.

1055 is an interface for inputting a value into the percent decline of the cost of goods should improvements be made. An input for the percent decline can be entered for the year before the improvement is implemented, and years one through five after the improvement is implemented. 1060 is an interface for inputting values into the revenue growth rate and credits percentage of the gross revenue. An input for the revenue growth rate and credit percentage of the gross revenue can be entered for the year before the improvement is implemented, and years one through five after the improvement is implemented.

1070 is an interface for inputting values into the dividend rate. An input for the dividend rate can be entered for the year before the improvement is implemented, and years one through five after the improvement is implemented.

1075 is an interface for inputting the entity valuation multiple. In some embodiments, the valuation multiple can be but is not limited to six, where improvements, such as but not limited to, the cost of goods are made. In some embodiments the valuation multiple as shown by interface 1075 is chosen or inputted by the user. In some embodiments the valuation multiple can depend on the type of entity being evaluated, and on market conditions.

In some embodiments, 1080 is an interface for displaying projection trends to contribution margin 1081, gross margin 1082, and EBITDA margin 1083, from a pre-improvement year to improvement implementation years, year 1 through year 5. In some embodiments, 1080 is a graph of projection trends to contribution margin 1081, gross margin 1082, and EBITDA margin 1083, from a pre-improvement year to improvement implementation years, year 1 through year 5. Again, in these embodiments, the projections are based on calculations provided by calculation unit 170 and as shown in the after improvements interface of FIGS. 100 and 10D.

In some embodiments, 1085 is an interface for displaying projection trends to the net revenue 1086, from a pre-improvement year to improvement implementation years, year 1 through year 5. In some embodiments, 1085 is a graph of projection trends to the net revenue 1086. Again, in these embodiments, the projections are based on calculations provided by calculation unit 170 and as shown in the after improvements interface of FIGS. 100 and 10D.

In some embodiments, 1090 is an interface for displaying projection trends to equity value 1091, cash beginning 1092, EBITDA 1093, funds from operations 1094, cash taxes 1095, and cash interest 1096, from years 1 through 6. In this embodiment, year 1 is a pre-improvement implementation year, and years 2 through 6 are the same as improvement implementation years 1 through 5 shown in interfaces 1080 and 1085. In some embodiments, 1090 is graph for displaying projection trends to equity value 1091, cash beginning 1092, EBITDA 1093, funds from operations 1094, cash taxes 1095, and cash interest 1096 for the same time period.

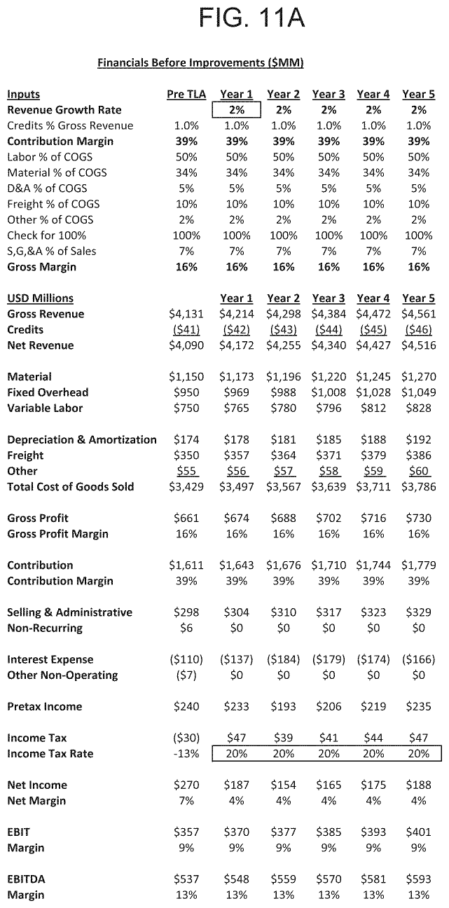

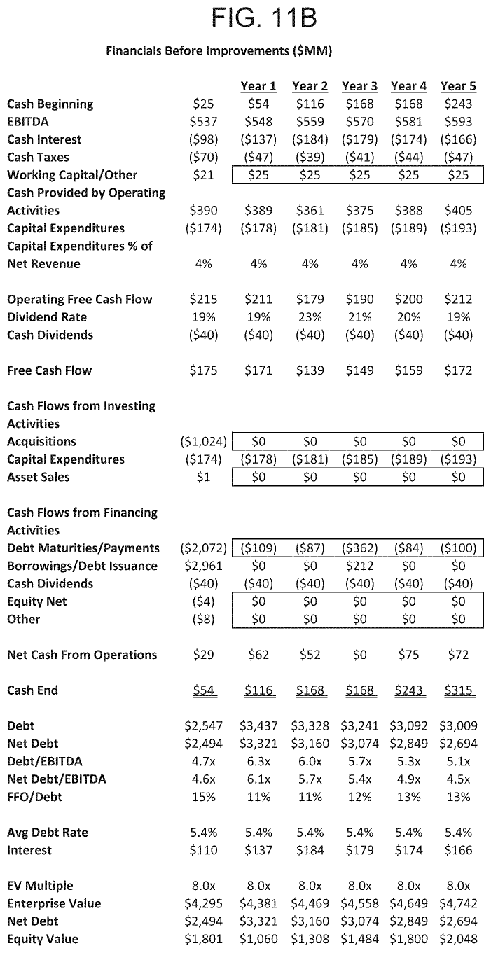

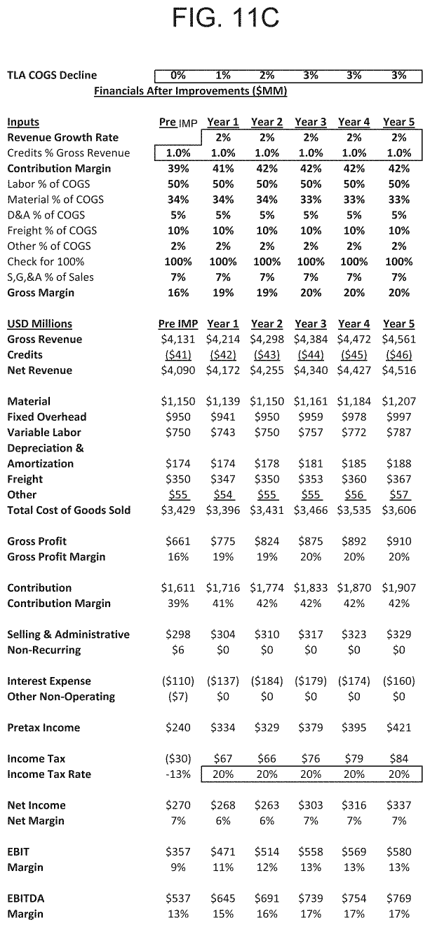

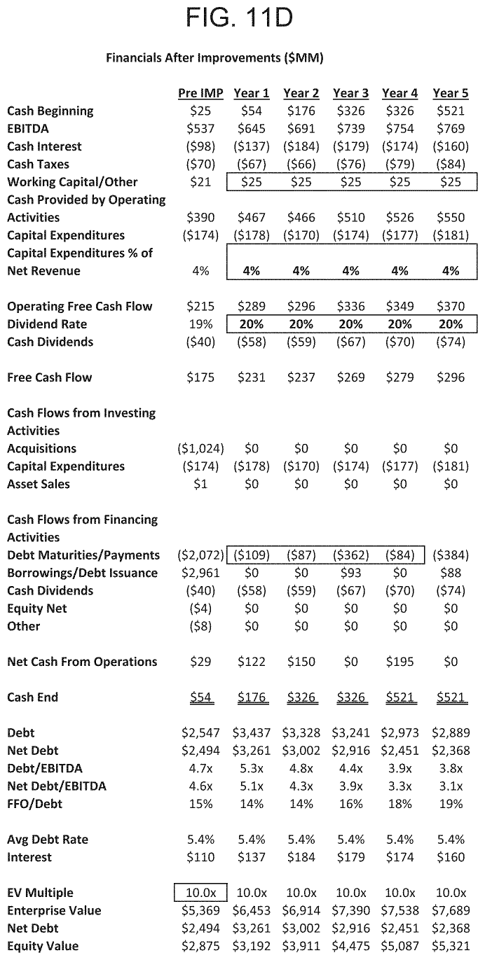

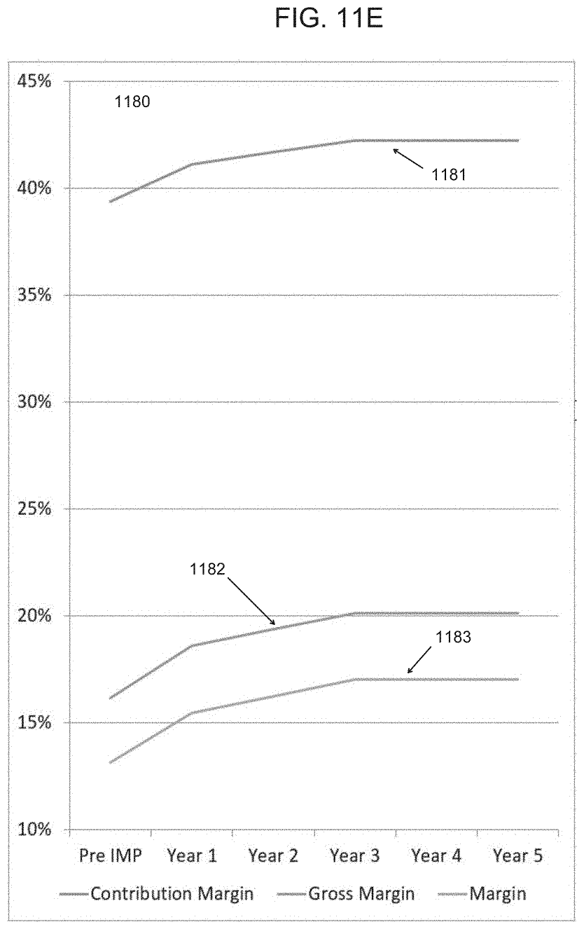

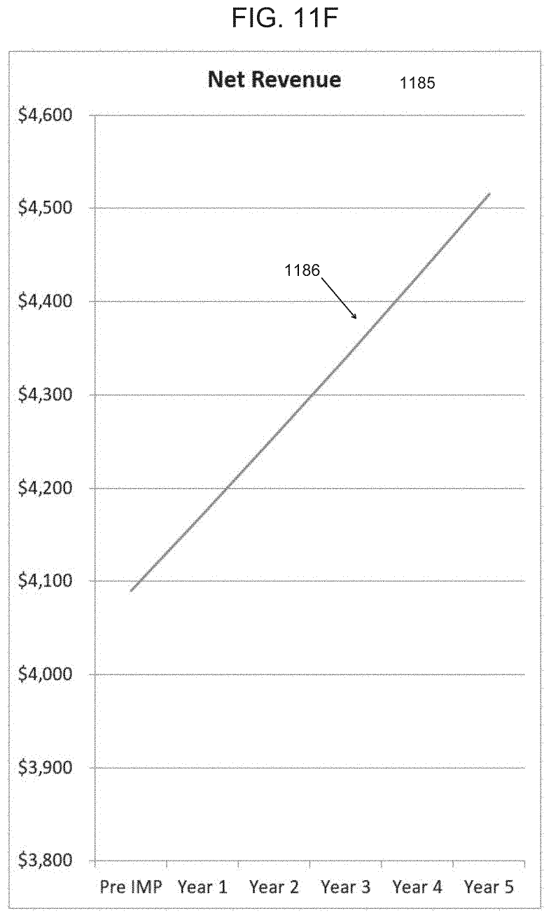

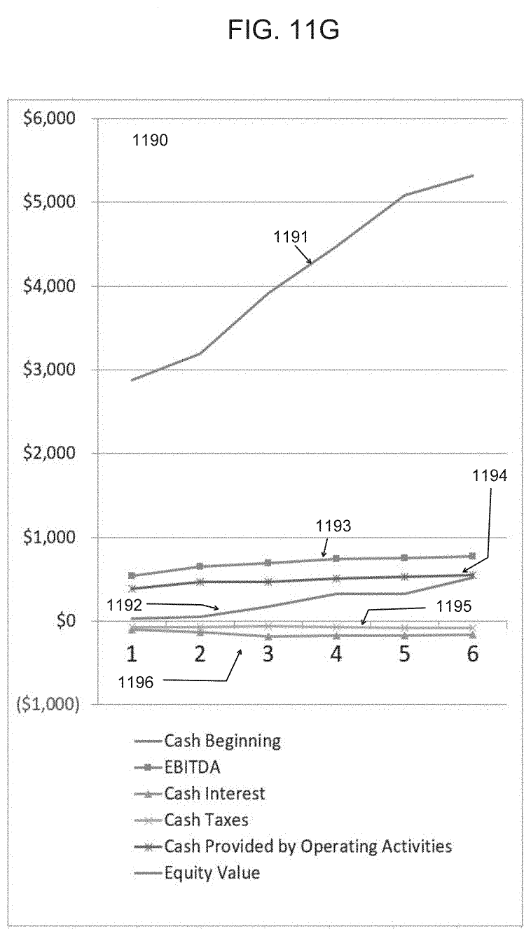

FIGS. 11A-11G are another embodiment of a user interface for a valuation and trend calculator used to implement the method and system disclosed herein. Calculator unit 170, calculation module 470, or calculator 500 can produce the values, and graphs and/or projections shown in FIGS. 11E-11G based on inputs by a user and/or data obtained from a 10-K form, such as Silgan Holding's 10-K form. The EV multiple can be entered by a user, or obtained from calculations from data such as EBITDA and Enterprise value (Valuation of Entity). The data for the entity used in the embodiment of FIGS. 11A-11G are obtained from Silgan Holding's 10-K form, which is publicly available, and is incorporated by reference into to this application. In some embodiments the outlined areas of FIGS. 11A-11D are areas which information or data is inputted by a user. Such data can include the revenue growth rate, working capital, acquisitions, asset sales, deb maturities, equity net, COGS decline, gross revenue, income tax rate, capital expenditures, dividend rate, and EV multiple.

COGs is an abbreviation for the cost of goods sold. D&A is an abbreviation for depreciation and amortization. S,G&A is an abbreviation for selling, general and administrative costs. EBIT is an abbreviation for earnings before interest and taxes. EBITDA is an abbreviation for earnings before interest, taxes, depreciation and amortization. CapEx is an abbreviation for capital expenditures. FFO is an abbreviation for funds from operations. Avg is an abbreviation for average. EV is an abbreviation for enterprise value. Imp is an abbreviation for improvement.

The calculator interface of FIGS. 11A-11D are divided into a before improvements interface as shown in FIGS. 11A and 11B, and an after improvement interface as shown in FIGS. 11C and 11D.

The before improvements Interface shown in FIGS. 11A and 11B provide projections from year one to year five, for an entity that does not make improvements, to various areas, such but not limited to, the cost of goods. In some embodiments, the revenue growth rate, income tax rate, working capital, acquisitions, debt maturities, cash dividends, and equity net found on the before improvements interface can be entered by a user and/or obtained from a 10-K form such as Silgan Holding's 10-K form.

The after improvements interface shown in FIGS. 11C and 11D provide projections from a year before improvements (Pre improvement/Pre TLA), to years one through five for an entity which makes improvements to areas such as, but not limited to, the cost of goods. In some embodiments, the COGS decline, revenue growth rate, credits % gross revenue, income tax, working capital, debt maturities and dividend rate found on the after improvements interface can be entered by a user and/or obtained from a 10-K form such as Silgan Holding's 10-K form.

In some embodiments, 1180 is an interface for displaying projection trends to contribution margin 1181, gross margin 1182, and EBITDA margin 1183, from a pre-improvement year to improvement implementation years, year 1 through year 5. In some embodiments, 1180 is a graph of projection trends to contribution margin 1181, gross margin 1182, and EBITDA margin 1183, from a pre-improvement year to improvement implementation years, year 1 through year 5. Again, in these embodiments, the projections are based on calculations provided by calculation unit 170, and/or data obtained from a 10-K form such as Silgan Holding's 10-K form, and as shown in after improvements interface FIGS. 11C and 11D.

In some embodiments, 1185 is an interface for displaying projection trends to the net revenue 1186, from a pre-improvement year to improvement implementation years, year 1 through year 5. In some embodiments, 1185 is a graph of projection trends to the net revenue 1186. Again, in these embodiments, the projections are based on calculations provided by calculation unit 170 and/or data obtained from a 10-K form such as Silgan Holding's 10-K form, and as shown in after improvements interface FIGS. 11C and 11D.

In some embodiments, 1190 is an interface for displaying projection trends to equity value 1191, cash beginning 1192, EBITDA 1193, cash provided by operating activities 1194, cash taxes 1195, and cash interest 1196, from years 1 through 6. In this embodiment, year 1 is a pre-improvement implementation year, and years 2 through 6 are the same as improvement implementation years 1 through 5 shown in interfaces 1180 and 1185. In some embodiments, 1190 is graph for displaying projection trends to equity value 1191, cash beginning 1192, EBITDA 1193, cash provided by operating activities 1194, cash taxes 1195, and cash interest 1196 for the same time period.

It should also be noted that the terms “first”, “second”, “third”, “upper”, “lower”, and the like may be used herein to modify various elements. These modifiers do not imply a spatial, sequential, or hierarchical order to the modified elements unless specifically stated.

It should be understood that elements or functions of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

While the present disclosure has been described with reference to one or more exemplary embodiments, it will be understood by those skilled in the art that various changes may be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure not be limited to the particular embodiment(s) disclosed as the best mode contemplated.

What is claimed is:

1. A method for providing a visual representation of updated entity valuations comprising:
acquiring entity data;
wherein the entity data further comprises data from the group consisting of valuation data, health and safety data, and operating efficiency and material losses data;
storing the entity data on a non-transitory computer readable medium;
calculating a baseline entity valuation and a baseline gross margin based on the entity data within seconds of retrieval from storage;
selecting areas of improvement based on desired entity requirements;
calculating an updated entity valuation and an updated gross margin for a future time period based on selected areas of improvement;
providing a visual representation of the baseline entity valuation and the baseline gross margin and the updated entity valuation and the updated gross margin.

2. The method of claim 1, further comprising the steps of acquiring benchmark data;
comparing the benchmark data to entity data;
calculating a magnitude for each variance between the entity data and benchmark data;
sorting the magnitudes from a least magnitude to a greatest magnitude;
wherein entity requirements are based on selecting an area of improvement corresponding to the greatest magnitude.

3. The method of claim 1, further comprising the steps of acquiring benchmark data;
wherein benchmark data further comprises, industry data sector data, and niche data;
wherein the industry data corresponds to a same industry of the entity data;
wherein the sector data corresponds to a same sector of the entity data;
wherein the niche data corresponds to a same niche of the entity data.

4. The method of claim 3, further comprising the steps of comparing the benchmark data to entity data;
calculating a magnitude for each variance between the entity data and industry data;
sorting the magnitudes from a least magnitude to a greatest magnitude;
wherein entity requirements are based on selecting an area of improvement corresponding to the greatest magnitude.

5. The method of claim 3, further comprising the steps of comparing the benchmark data to entity data;
calculating a magnitude for each variance between the entity data and sector data;
sorting the magnitudes from a least magnitude to a greatest magnitude;
wherein entity requirements are based on selecting an area of improvement corresponding to the greatest magnitude.

6. The method of claim 3, further comprising the steps of comparing the benchmark data to entity data;
calculating a magnitude for each variance between the entity data and niche data;
sorting the magnitudes from a least magnitude to a greatest magnitude;
wherein entity requirements are based on selecting an area of improvement corresponding to the greatest magnitude.

7. The method of claim 1, wherein entity requirements are based on receiving a user input.

8. A system comprising;
a processor; and
a non-transitory computer readable medium that contains instructions that are readable by the processor to cause the processor to perform the operations of:
collecting entity data;
storing the entity data on the non-transitory computer readable medium;
calculating a baseline entity valuation and a baseline gross margin based on the entity data within seconds of retrieval from storage;
selecting areas of improvement based on selected entity requirements;
calculating an updated entity valuation and an updated gross margin for a future time period based on selected areas of improvement;
providing a visual representation on a display of the baseline entity valuation and the baseline gross margin and the updated entity valuations and the updated gross margins.

9. The system of claim 8, wherein the entity data further comprises data from the group consisting of valuation data, health and safety data, and operating efficiency and material losses data.

10. The system of claim 9, further comprising the operations of acquiring benchmark data;
comparing the benchmark data to entity data;
calculating a magnitude for each variance between the entity data and benchmark data;
sorting the magnitudes from a least magnitude to a greatest magnitude;
wherein entity requirements are based on selecting an area of improvement corresponding to the greatest magnitude.

11. The system of claim 8, further comprising the operations of acquiring benchmark data;
wherein benchmark data further comprises, industry data sector data, and niche data;
wherein the industry data corresponds to a same industry of the entity data;
wherein the sector data corresponds to a same sector of the entity data;
wherein the niche data corresponds to a same niche of the entity data.

12. The system of claim 11, further comprising the steps of comparing the benchmark data to entity data;
calculating a magnitude for each variance between the entity data and industry data;
sorting the magnitudes from a least magnitude to a greatest magnitude;
wherein entity requirements are based on selecting an area of improvement corresponding to the greatest magnitude.

13. The system of claim 11, further comprising the steps of comparing the benchmark data to entity data;
calculating a magnitude for each variance between the entity data and sector data;
sorting the magnitudes from a least magnitude to a greatest magnitude;
wherein entity requirements are based on selecting an area of improvement corresponding to the greatest magnitude.

14. The system of claim 11, further comprising the steps of comparing the benchmark data to entity data;
calculating a magnitude for each variance between the entity data and niche data;
sorting the magnitudes from a least magnitude to a greatest magnitude;
wherein entity requirements are based on selecting an area of improvement corresponding to the greatest magnitude.

15. The system of claim 8, wherein entity requirements are based on receiving a user input.

16. The system of claim 9, wherein the user input is received through a user input device and a graphical user interface;
wherein the graphical user interface is provided on the display and is configured to provide the visual representation.

17. A system comprising;
a processor; and
a non-transitory computer readable medium that contains instructions that are readable by the processor to cause the processor to perform the operations of:
collecting entity data;
wherein the entity data comprises data from the group consisting of valuation data, health and safety data, and operating efficiency and material losses data;
storing the entity data on the non-transitory computer readable medium;
calculating a baseline entity valuation and a baseline gross margin based on the entity data within seconds of retrieval from storage;
selecting areas of improvement based on a user input received through a user input device and a graphical user interface;
calculating an updated entity valuation and an updated gross margin for a future time period based on each selected area of improvement;
providing a visual representation on a display of the baseline entity valuation and the baseline gross margin and each of the updated entity valuations and each of the updated gross margins.
